(19) United States
(12) Patent Application Publication
(10) Pub. No.: US 2020/0040975 A1
(43) Pub. Date: Feb. 6, 2020

(54) HYDRAULICALLY ACTUATED STATOR CLUTCH

(71) Applicant: SCHAEFFLER TECHNOLOGIES AG & CO. KG, HERZOGENAURACH (DE)

(72) Inventor: Victor NORWICH, Wooster, OH (US)

(21) Appl. No.: 16/049,892

(22) Filed: Jul. 31, 2018

(51) Int. Cl. F16H 45/02; F16D 25/0638; F16H 41/24; F16H 61/14

(52) U.S. Cl. CPC F16H 45/02; F16D 25/0638; F16H 2045/0284; F16H 61/14; F16H 41/24

(57) ABSTRACT

A torque converter having a hydraulically-actuated stator clutch therein is provided. In particular, the torque converter includes a stator, and a hub axially aligned with at least a portion of the stator and located radially inward of at least a portion of the stator. The hydraulically-actuated stator clutch is disposed within the stator and is configured to selectively couple the stator to the hub. The hub defines a dedicated fluid passageway extending therethrough to fluidly couple a transmission fluid source to the hydraulically-actuated clutch. Slipping of the clutch is therefore controlled via hydraulic fluid. This allows for modification of characteristics of the torque converter that are not otherwise possible with standard one-way clutches in torque converter stators.

### TECHNICAL FIELD

The present disclosure relates generally to torque converters, and more specifically to clutches within the torque converters.

### BACKGROUND

Torque converters are known in the art. Torque converters typically include a pump (or impeller), a turbine, and a stator. The stator may have a one-way clutch. In a torque multiplication mode, when the ratio of the turbine rotational speed to the pump rotational speed is below a value associated with a coupling point (e.g., by about 0.9), the stator rotates in one direction to rotationally lock the one-way clutch and the stator with the stator shaft. In a coast or drive mode, when the ratio is at or above the value associated with a coupling point, the stator may freely rotate in the opposite direction.

### SUMMARY

In one embodiment, a torque converter having a hydraulically-actuated stator clutch therein is provided. In particular, the torque converter includes a stator, and a hub axially aligned with at least a portion of the stator and located radially inward of at least a portion of the stator. The hydraulically-actuated stator clutch is disposed within the stator and is configured to selectively couple the stator to the hub. The hub defines a dedicated fluid passageway extending therethrough to fluidly couple a transmission fluid source to the hydraulically-actuated clutch. Slipping of the clutch is therefore controlled via hydraulic fluid. This allows for modification of characteristics of the torque converter that are not otherwise possible with standard one-way clutches in torque converter stators.

In another embodiment, a torque converter includes a stator extending about an axis and defining an axially-extending pocket. A hub extends about the axis and is configured to be non-rotatably connected to a transmission input shaft. A hydraulically-actuated stator clutch disposed in the pocket.

In yet another embodiment, a torque converter includes a cover, an impeller non-rotatably fixed to the cover and extending about an axis, and a turbine extending about the axis. A stator is disposed at least partially axially between the impeller and the turbine. The stator defines an axially-extending pocket. A hub is radially inward of at least a portion of the stator and is configured to couple about a transmission input shaft. A hydraulically-actuated stator clutch is disposed within the pocket and is configured to, upon a controllable hydraulic actuation, couple the stator to the hub.

### BRIEF DESCRIPTION OF THE DRAWINGS

FIG. 1 is a partial cross-sectional view of a torque converter with a hydraulically-actuated stator clutch, according to one embodiment.

FIG. 2 is a plot showing the operating characteristics of the torque converter of FIG. 1, according to one embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In a typical vehicular automatic transmission, driving power from the engine is transmitted to the transmission via transmission fluid or oil. A torque converter can provide torque multiplication during acceleration and low-speeds, for example. Typically, torque converter's stator can include or be associated with a one-way clutch. During vehicle low speeds or accelerations, for example, the stator can lock and remain stationary due to its one-way clutch, creating a vortex and resulting in torque multiplication. The stator can remain locked until the torque converter reaches its coupling phase, in which the speed of the turbine increases to almost reach the speed of the impeller (e.g., 90% of the impeller speed). Once in the coupling phase, the fluid exiting the turbine has changed enough to contact the opposite side of the stator blades, which attempts to forward-rotate the stator. At this point, the stator clutch releases and the stator is allowed to spin freely; the impeller, turbine and stator can rotate together.

According to embodiments disclosed herein, the standard one-way clutch in the stator can be removed and replaced by a hydraulically-actuated stator clutch. Details of the hydraulically-actuated stator clutch is disclosed herein, with reference to the Figures. As will be described, the hydraulically-actuated stator clutch can include a dedicated oil line to actuate the piston of the clutch, compressing the clutch plates and closing the clutch. The slip of the clutch within the stator can be controlled, allowing modification of the torque converter characteristics that are not otherwise possible with standard one-way clutches in torque converter stators.

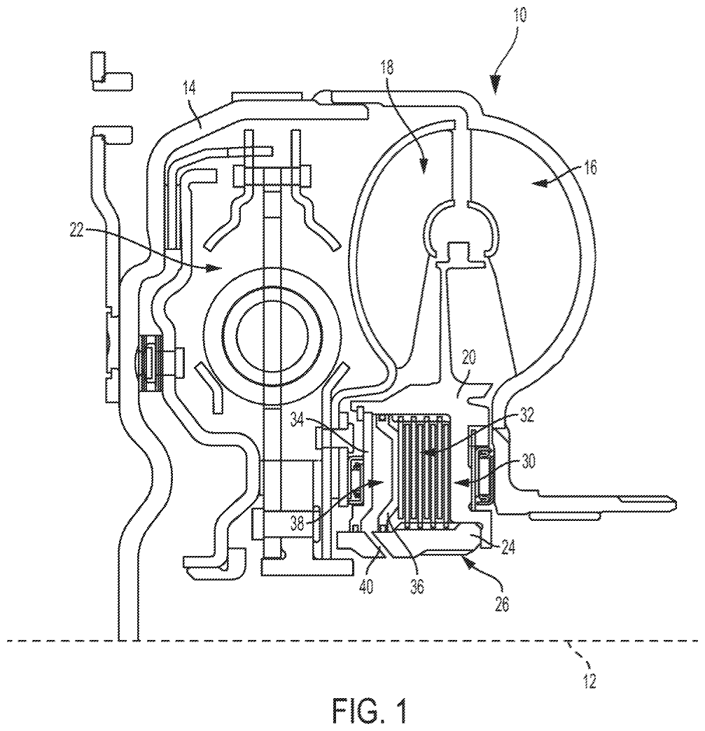

Referring to FIG. 1, a portion of a torque converter 10 is illustrated according to one embodiment. At least some portions of the torque converter 10 are rotatable about a central axis 12. While only a portion above the axis is shown in FIG. 1, it should be understood that the torque converter can appear substantially similar below the axis with many components extending about the axis. Words such as “axial,” “radial,” “circumferential,” “outward,” etc. as used herein are intended to be with respect to the central axis 12. Power from a vehicle engine (not shown) can be transmitted to a transmission via fluid, and via the torque converter. In particular, the power may first be transmitted to a front cover 14 of the torque converter 10. A pump or impeller 16 is integrally connected to or fastened to the front cover 14 such that the impeller rotates as the front cover rotates. The impeller 16 includes blades that, when rotated about the axis 12, push the fluid outwardly. The fluid pushes against a turbine 18 of the torque converter, causing the turbine 18 to revolve about the axis 12. A stator 20 functions to return the fluid from the turbine 18 back to the impeller 16 with minimal or no power loss. Drive power is transmitted from the turbine 18 to an input shaft of the transmission.

In the illustrated embodiment, the turbine 18 is also connected to a damper assembly 22 that is circumferentially drivable by the turbine and is positioned between the turbine 18 and the front cover 14.

A clutch 30 is located within the stator 20. According to the illustrated embodiment, the clutch 30 is a hydraulically actuated stator clutch in that the clutch is actuated in response to application of hydraulic fluid. In one example, the torque converter 10 includes a hub 24 (also referred to as a stator hub) fixed to rotate with a transmission input shaft via, for example, a spline connection at 26. In this fashion, the hub 24 is non-rotatably connected to the transmission input shaft, as the two components rotate together and one cannot rotate relative to the other. The clutch 30 includes a plurality of clutch plates 32. Some of the clutch plates interface with (or are connected directly to) the hub 24, while some other of the clutch plates interface with (or are connected directly to) the stator 20. When the clutch 30 is open, the hub 24 is free to rotate relative to the stator 20. In another embodiment, the hub 24 is a (e.g., non-rotatable) stator shaft associated with the transmission input shaft.

The hydraulically actuated stator clutch 30 includes a stator reaction plate 34 axially spaced from a stator piston 36. An axial gap between the reaction plate 34 and the piston 36 defines a clutch fluid application chamber 38. Upon a supply of pressurized fluid into the chamber 38, the piston 36 slides axially (e.g., to the right in the orientation shown in FIG. 1) to compress the clutch plates 32. When fully applied to compress the clutch plates 32, this defines a closed or locked mode of operation of the clutch 30. When the clutch 30 is locked, rotation between the stator 20 is forced to rotate along with the hub 24 and connected transmission input shaft. Upon a release or relief of the fluid from the chamber 38, the piston 36 can slide axially in an opposite direction (e.g., to the left in the orientation shown in FIG. 1) to allow the clutch plates 32 to decompress from one another. When minimal or no fluid pressure is applied in the chamber 38 such that the piston 36 does not compress the clutch plates 32, this defines an open or unlocked mode of operation of the clutch 30. In the open or unlocked mode of operation, the stator 20 is not rotationally fixed to the hub 24 and is free to rotate relative to the hub 24 and connected transmission input shaft.

The hydraulically actuated stator clutch 30 may be axially bounded entirely by the stator. In other words, the stator 20 may extend axially between a first axial end and a second axial end, and the clutch 30 may be disposed axially between the first and second axial ends.

The hydraulic actuation of the clutch 30 allows the clutch 30 to be controlled between the locked and unlocked modes. The slip of the clutch 30 can be controlled; a fixed, controlled amount of slip in the clutch is allowed with the torque converter as described herein. When the clutch is slipping, this can be referred to as a slipping mode in which the stator 20 is partially rotationally fixed with the hub 24 and an amount of slipping is controllable by varying an amount of fluid passing through the dedicated fluid passageway 40. This allows modification of the torque converter operation characteristics anywhere between the fully locked and unlocked modes that is otherwise not possible with standard one-way clutches typically found in a torque converter.

The hydraulically actuated stator clutch 30 is provided with its own dedicated fluid or oil port 40. The oil port 40 passes radially through the stator hub 24. This allows a direct fluid coupling between the fluid application chamber 38 and the transmission. Pressurized transmission fluid can pass through the oil port 40 and into the chamber 38 to hydraulically actuate the clutch 30. While not shown in FIG. 1, the valve body of the transmission may have an additional valve and porting to supply the pressurized fluid to the oil port 40.

Seals may be provided on either side of the dedicated oil port 40. For example, a first seal may be provided on a first axial side of the passage 40, and a second seal may be provided on a second axial side of the passage 40. The seals allow the dedicated passage 40 to direct fluid through the stator hub 24 and into the fluid application chamber 38 without receiving fluid from or interference with fluid in the remainder of the torque converter. In one embodiment, two seals are integrated into the input shaft or formed by the input shaft. A fluid passage hole or aperture would be located radially inward of the stator hub 24, aligned with the passage 40 to allow fluid to enter through the seal and into the fluid application chamber 38.

In another embodiment not depicted in the Figures, a diaphragm spring is provided. In such an embodiment, the fluid application chamber 38 can be vented to the sump of the transmission. This can save the need for a control valve within the transmission since there would be a lack of need to control the pressure in the fluid application chamber. In particular, for a stator clutch to be engaged, a pressure differential across the clutch is typically required. In the illustrated embodiments, this is accomplished by having a controlled pressure flow through the stator shaft, and into the fluid application chamber to act on one side of the piston. This assumes that this pressure is higher than the charge pressure. If additional pressure in the application chamber is required, a coil spring or diaphragm spring may be present to provide additional pressure.

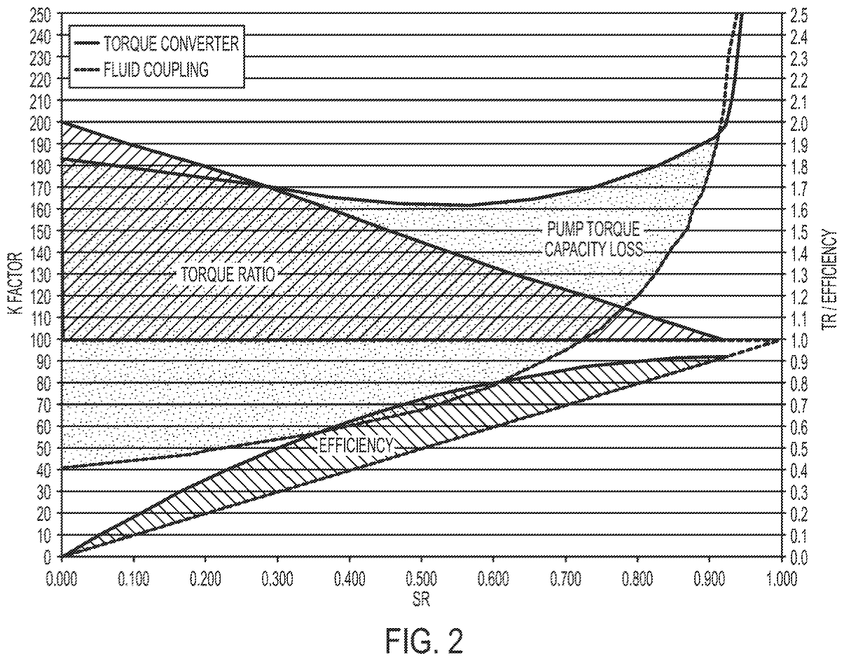

FIG. 2 represents torque converter characteristics in drive condition, in which the capacity factor (or “K factor,” i.e., the ratio of impeller speed to square root of impeller torque) is plotted against the speed ratio “SR” and the torque ratio “TR” or efficiency of the output torque over the input torque. A goal of slipping clutch is to be able to vary the performance anywhere in those regions. The downside is that anytime clutch is slipped, efficiency is lost. However, this sacrifice is still beneficial to modulate performance of the transmission.

The hydraulically-actuated stator clutch with its own dedicated fluid application port and chamber, as described herein, provides advantages over previous designs. For example, previous designs with a friction one-way clutch in the stator do not allow for a controllable amount of slip. While there may be a transitional point (i.e., between disengagement and engagement of the clutch) with slight slip, there is no control over that slip and the slip only exists during a commanded transition between the disengagement and engagement of the clutch; as the fluid is rotated, an axial load on the stator actuates the clutch and it operates like a one-way clutch. Conversely, the hydraulically-actuated stator clutch of this disclosure provides a controllable amount of slip of the clutch with its own dedicated fluid passage leading to a fluid clutch actuation chamber.

Parts List

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment
10 torque converter
12 central axis
14 front cover
16 impeller or pump
18 turbine
20 stator
22 damper assembly
24 stator hub
26 spline connection
30 stator clutch
32 stator clutch plates
34 stator reaction plate
36 stator piston
38 fluid application chamber
40 dedicated fluid passageway

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A torque converter comprising:
a stator;
a hub axially aligned with at least a portion of the stator and located radially inward of at least a portion of the stator, and
a hydraulically-actuated clutch disposed within the stator and configured to selectively couple the stator to the hub;
wherein the hub defines a dedicated fluid passageway extending therethrough to fluidly couple a transmission fluid source to the hydraulically-actuated clutch.

2. The torque converter of claim 1, wherein the hydraulically-actuated clutch allows the torque converter to operate in:
a locked mode in which the stator is rotationally fixed with the hub,
a unlocked mode in which the stator and the hub are not rotationally fixed, and
a slipping mode in which the stator is partially rotationally fixed with the hub.

3. The torque converter of claim 2, wherein an amount of slipping during the slipping mode is controllable by varying an amount of fluid passing through the dedicated fluid passageway.

4. The torque converter of claim 1, wherein the hydraulically-actuated clutch includes a plurality of clutch plates collectively compressible along an axis.

5. The torque converter of claim 4, further comprising a stator reaction plate and a stator piston defining a fluid application chamber therebetween, wherein the dedicated fluid passageway has an outlet configured to supply fluid to the fluid application chamber, and wherein a supply of the fluid to the fluid application chamber via the dedicated fluid passageway forces the stator piston to engage the clutch plates.

6. The torque converter of claim 5, wherein an amount of a fluid pressure supplied to the hydraulically-actuated clutch is controllable to control an amount of slip of the hydraulically-actuated clutch.

7. The torque converter of claim 1, wherein the stator defines an axially-extending pocket, and the hydraulically-actuated clutch is disposed within the pocket.

8. The torque converter of claim 1, further comprising a turbine and an impeller, wherein the dedicated fluid passageway enables fluid to engage the hydraulically-actuated clutch directly from a fluid supply source other than the turbine or the impeller.

9. A torque converter comprising:
a stator extending about an axis and defining an axially-extending pocket;
a hub extending about the axis and configured to be non-rotatably connected to a transmission input shaft; and
a hydraulically-actuated stator clutch disposed in the pocket.

10. The torque converter of claim 9, wherein the hydraulically-actuated stator clutch includes a first plurality of clutch plates attached to the stator, and a second plurality of clutch plates attached to the hub, wherein hydraulic actuation of the hydraulically-actuated stator clutch at least partially couples the stator to the hub.

11. The torque converter of claim 10, wherein an amount of hydraulic pressure applied to the hydraulically-actuated stator clutch is controllable to enable a controlled amount of slipping of the hydraulically-actuated stator clutch.

12. The torque converter of claim 10, further comprising a stator piston slideable along the axis within the pocket and configured to selectively compress the first and second plurality of clutch plates to engage the clutch.

13. The torque converter of claim 12, further comprising a stator reaction plate axially spaced from the piston, wherein a fluid application chamber is defined axially between the stator reaction plate and the piston, and wherein an application of hydraulic pressure is applied to the stator piston to selectively engage the clutch.

14. The torque converter of claim 13, wherein the hub defines a dedicated fluid passage extending through the hub and fluidly connecting a transmission to the fluid application chamber.

15. The torque converter of claim 10, wherein the hub defines a dedicated fluid passage extending through the hub and enabling transmission fluid to enter a clutch actuation chamber of the clutch.

16. A torque converter comprising:
a cover;
an impeller non-rotatably fixed to the cover and extending about an axis;
a turbine extending about the axis;
a stator disposed at least partially axially between the impeller and the turbine, wherein the stator defines an axially-extending pocket;
a hub radially inward of at least a portion of the stator and configured to couple about a transmission input shaft a hydraulically-actuated stator clutch disposed within the pocket and configured to, upon a controllable hydraulic actuation, couple the stator to the hub.

17. The torque converter of claim 16, wherein the hydraulically-actuated stator clutch includes a plurality of clutch plates configured to, upon the controllable hydraulic actuation, collectively axially compress.

18. The torque converter of claim 17, further comprising a piston slidably received radially between the stator and the hub, the piston configured to, upon the controllable hydraulic actuation, slide axially to press against one of the clutch plates.

19. The torque converter of claim 18, further comprising a reaction plate axially spaced from the piston to define a fluid application chamber therebetween, wherein fluid when pressurized enters the fluid application chamber to perform the controllable hydraulic actuation.

20. The torque converter of claim 19, wherein the hub defines a dedicated fluid passageway extending outwardly therethrough, the dedicated fluid passageway fluidly coupling a transmission fluid source to the fluid application chamber.
